(19) United States
(12) Patent Application Publication
(10) Pub. No.: US 2020/0406745 A1
(43) Pub. Date: Dec. 31, 2020

(54) Motor vehicle tank having volume element

(71) Applicant: KAUTEX TEXTRON GmbH & Co. KG, Bonn (DE)

(72) Inventors: Emmanuel ARRAS, Munchen (DE); Manfred BIGALKE, Vaterstetten (DE); Axel FROHWEIN, Neufahrn (DE); Markus HUBER, Munchen (DE); Attila FARKAS, Munchen (DE); Tim WALTER, Koln (DE); Daniel HARMS, Hennef (DE); Gernot WEISS, Neunkirchen-Seelscheid (DE); Theodor OSSEGE, Rheinbreitbach (DE); Jorg KOITH, Neunkirchen-Seelscheid (DE); Christoph MEHREN, Hurtgenwald (DE); Roman BOUFFIER, Konigswinter (DE)

(21) Appl. No.: 16/976,552

(22) PCT Filed: Feb. 26, 2019
(86) PCT No.: PCT/EP2019/054711

§ 371 Date: Aug. 28, 2020

(30) Foreign Application Priority Data
Feb. 28, 2018 (DE) 10 2018 203 006.5

(51) Int. Cl. B60K 15/03; B29C 49/20; B29L 31/00; B60K 15/035

(52) U.S. Cl. CPC B60K 15/03177; B29C 49/20; B60K 2015/03046; B29L 2031/7172; B60K 15/03504; B60K 2015/03085

(57) ABSTRACT

A fuel tank for receiving a fluid in a motor vehicle. The fuel tank includes an outer wall forming an internal space for receiving the fluid. At least one volume element is arranged in the internal space for receiving air, and an opening that is a gas-guiding line between the volume element and the environment of the tank is for changing the volume of the volume element. The at least one volume element is formed at least partially as bellows.

The invention relates to a tank in a motor vehicle for holding a fluid, particularly fuel. The tank has a gas-filled volume element having a variable volume.

Hydrocarbon emissions from fuel tanks must be prevented to the greatest extent possible due to their environmentally damaging effect. Hydrocarbon vapors result from the high partial pressure of the hydrocarbons in the fuel, particularly at higher temperatures. Three essential processes lead to the potential discharge of hydrocarbon vapors out of the fuel tank. One process is the permeation of hydrocarbon molecules through the outer wall of the tank. This process is largely understood and existing solutions result in a sufficient reduction of the emission. A second process is the refueling process. Filling the tank with liquid fuel requires displacing the gas, which is saturated with hydrocarbons, located in the tank. There are two main approaches for capturing these gases: onboard refueling vapor recovery (ORVR) with large activated carbon filters (ACF) or the suctioning of the gas by the fuel nozzle of the filling station. Third, when parked or when the internal combustion engine is not running, gases result due to a change in the ambient temperature, known as diurnal or parking emissions. These can also be buffered by means of an activated carbon filter if the activated carbon filter is subjected to a proper purging process on a regular basis. To this end, the internal combustion engine must usually be in operation. This may be relatively elaborate, particularly in regard to hybrid vehicles having electric motors and internal combustion engines since the internal combustion engine is not always in operation.

One way to reduce HC emissions without pressurizing the tank consists of creating an unpressurized tank having an integrated volume element, which compensates for a generated gas volume by means of a volume change. To this end, the volume element must be as emissions-proof as possible with respect to the hydrocarbons so that there is always air inside said volume element, which can be pressed out of the tank system directly into the atmosphere or suctioned into said volume element. In addition, the volume element must be so easily deformable that a pressure difference of a few millibars (up to ±20 mbar) suffices to ensure complete filling and emptying. Furthermore, the volume change (maximum volume minus minimum volume) of the volume element must be dimensioned in such a manner that the gas volume produced by evaporation in the event of a temperature increase can be compensated for in a pressure-neutral manner or at a low pressure.

WO 2016/012284 depicts various embodiments of the volume body.

It is an object of the invention to specify a tank, particularly a fuel tank, of a motor vehicle, which given a simple structure allows operation of the motor vehicle in the most low-maintenance, reliable and environment-friendly manner possible.

The object is solved by the features of the independent claims. The dependent claims have advantageous embodiments of the invention as their subject matter.

Thus, the object is solved by a tank, in particular designed as a fuel tank. The tank is designed to be arranged in a motor vehicle and to hold a fluid. The motor vehicle is in particular a road vehicle, for example a car, truck or motorcycle. In a particularly preferred manner, the motor vehicle is a hybrid vehicle with an electric motor and an internal combustion engine. The fluid to be held by the tank is preferably fuel, for example gasoline or diesel.

The tank comprises an outer wall. This outer wall forms an interior space for holding the fluid. Furthermore, the tank comprises at least one volume element arranged in the interior space. The volume element is designed for holding gas. The gas is in particular air from the surroundings of the tank.

The reservoir volume formed by the outer wall, except for the volume occupied by the volume element, can thus be used to hold the fluid.

Furthermore, the tank comprises a line between the volume element and the surroundings of the tank or at least an opening of the volume element to the surroundings. The line connects the volume element in a gas-carrying manner through the outer wall to the surroundings. The opening connects the volume element in a gas-conducting manner through the outer wall to the surroundings. By means of the line or opening, the gas can flow from the volume element to the outside or from the outside into the volume element. As a result, the mass of gas in the volume element changes so that the volume of the volume element also changes when the pressure in the interior space and/or the fill quantity in the interior space change(s). The volume element can thus “breathe.”

The gas is in particular air, which is drawn from the atmosphere and from the line, respectively, or which flows through the opening back into the atmosphere. In particular, the air flows out of the volume reservoir through a filter, preferably a dust filter, into the atmosphere.

In particular, the volume element has its minimum volume when the tank is completely filled with fluid and is continually filled with gas when fluid is removed from the tank. In the context of renewed filling of the tank, the volume element is then emptied into the surroundings. The following explains the operating principle of the volume element: When the saturation vapor pressure of a fuel located in the tank changes (e.g., when parked), the thereby normally resulting pressure change will be compensated for. For example, if the fuel temperature fluctuates substantially over the course of the day (e.g., 20° C. in the morning, 40° C. at noon, 20° C. at night), the change in the saturation vapor pressure can be compensated for by means of the volume element. The volume element hereby has its minimum volume at the maximum fuel temperature, while its volume is at a maximum when the fuel temperature is at a minimum. WO 2016/012284 describes the functioning of the volume element in detail.

Several of the volume elements described here can also be arranged in the interior space of the tank. The volume elements may be designed identically or differently.

The at least one volume element is designed at least partially as bellows. The bellows comprise a plurality of folds, which result from an alternating arrangement of inward folding points and outward folding points. So-called intermediate surfaces of the bellows extend between the folding points. Bellows with only one, spiral-shaped circumferential fold are also possible.

When unfolding and folding, the bellows move parallel to an imaginary fold axis (also referred to as: Z-axis). This fold axis, along which the bellows unfold and fold together again, is preferably perpendicular to the top side of the outer wall of the tank.

### Construction of the Bellows

Preferably the volume element comprises a first element wall and an oppositely disposed second element wall. The bellows extend between the two element walls. The fold axis is preferably perpendicular to the element walls.

The first element wall and/or the second element wall are/is preferably designed of or comprise panels. The panels are preferably rigid. Furthermore, the element wall may also be formed of the material of the bellows, if applicable reinforced by a structure reinforcing element.

Preferably, the bellows are blow-molded to the first element wall and/or the second element wall, each designed as a panel. The “blow-molding” is carried out particularly by the first element wall and/or the second element wall being inserted together with the preform into the blow-molding tool. In the blow-molding tool, the preform is blown into bellows, wherein by means of the blow-mold pressure, the material of the preform is pressed against the first element wall and/or the second element wall, by means of which the elements bond. During blow-molding, the material of the bellows extends over the entire surface of the panel, by means of which the bellows and panel join together over the entire surface.

In an alternative to “blow-molding,” the panel is inserted into the preform during the blow-molding process. The basic geometry of the panel is adapted to the geometry of the molded part. When closing the blow-molding tool, the edges of the panel are peripherally welded to the preform.

According to another alternative, the panel can also be joined to the bellows in a material-bonded and/or form-fitting manner. In particular, the respective element wall is adhesively attached, welded and/or riveted to the bellows. This occurs after the bellows are blow-molded.

In a simple design of the element wall (first and/or second element wall), in particular designed as a panel, the element wall is formed of a single-layer material. It is alternatively provided that the element wall has at least two layers. These two layers are an inner layer and an outer layer. The outer layer is thereby produced of a different material than the inner layer. Alternatively, it is preferably provided that the element wall has at least three layers. These three layers are an inner layer, a middle layer and an outer layer. The middle layer is thereby produced of a different material than the inner layer and the outer layer. The inner layer and the outer layer may be produced of the same material or different materials. The middle layer is designed as a barrier layer to meet the emission requirements, as is preferably also provided for in regard to the middle layer of the bellows. For the middle layer of the element wall, preferably an ethylene vinyl alcohol copolymer (EVAL or EVOH), polyoxymethylene (POM) or polyamide (PA), particularly aliphatic polyamide, aromatic polyamide or partially aromatic polyamide (PPA) is used. The material of the inner layer of the element wall is preferably compatible with the material of the inner layer of the bellows so that these materials form a material bond.

The element wall (first and/or second element wall), particularly designed as a panel, is preferably a multicomponent injection-molded part or a presswork component from a multilayer extrusion.

The element wall can also be formed at least partially by the bellows.

Particularly when the element wall is formed by the bellows without using rigid panels, one can integrate circumferential radial folds in the bottom of the bellows so that the bottom can move somewhat upward inside the external folds to further decrease the minimum volume (compressed state of the volume element). In this case, the element wall is not a rigid panel, but the bottom of the bellows forms the second element wall.

Particularly when the element wall is formed by the bellows without using rigid panels, it shall be preferably provided that the element wall comprises at least a structure reinforcing element. This structure reinforcing element is preferably ring-shaped. The “ring shape” comprises all forms, e.g., circular, oval, polygonal, and is not limited to a closed, fully circumferential ring. The structure reinforcing element may in particular be blow-molded to the bellows or be joined afterward in a materially bonded and/or form-fitting manner to the bellows, particularly adhesively joined, welded and/or riveted. The structure reinforcing element can be combined with the radial folds in the bottom of the bellows.

The first element wall is preferably located on the top side of the tank. In particular, the first element wall is attached to the top side of the tank.

On the first element wall, preferably in the panel, there is preferably designed a connector, for example a nipple, which projects outwardly through the outer wall of the tank and can thereby be connected to the gas-carrying line. In particular, the volume element can also be attached to the outer wall by this connection being inserted in a corresponding hole of the outer wall.

### Layer Composition of the Bellows

In a simple design, the bellows are formed of a single-layer material. Alternatively, it is provided that the bellows have at least two layers. These two layers are an inner layer and an outer layer. The outer layer is thereby produced of a different material than the inner layer.

Alternatively, it is provided that the bellows has at least three layers. These three layers are an inner layer, a middle layer and an outer layer. The middle layer is thereby produced of a different material than the inner layer and the outer layer. The inner layer and the outer layer may be produced of the same material or different materials.

The individual layers are preferably adhesively joined or laminated on top of each other. A bonding agent layer may be used between the layers.

The layers are “function layers” and may in turn themselves be produced of multiple single layers. In particular, it is provided that the middle layer is formed of multiple single layers.

The material of the outer layer has in particular an e-module (elasticity module) of 60 to 1,100 MPa (megapascals). Preferably, the material of the outer layers has an e-module of 60 to 200 MPa or 500 to 1,100 MPa.

The material of the inner layer has in particular an e-module of 60 to 1,100 MPa. Preferably the material of the inner layer has an e-module of 60 to 200 MPa or 500 to 1,100 MPa.

For the outer layer and the inner layer, materials are preferably selected, which have a barrier effect with respect to polar components in a fluid and gaseous form (e.g., water, ethanol and so on) as well as non-polar components, and preferably a resistance to fluids, particularly fuel. For the middle layer, a material is preferably selected that inhibits fuel emissions.

In particular, polyethylene or a polyethylene-containing material is used for the outer and/or inner layer. Particularly suited for this is polyethylene of the PE-HD (high density polyethylene) type or PE-LD (low density polyethylene) or PE-LLD (linear, low-density polyethylene) or PE-HMW (high molecular weight polyethylene) or PE-UHMW (ultra-high molecular weight polyethylene) or PE-MD (medium density polyethylene). Alternatively, one can use more elastic materials such as TPE (thermoplastic elastomer), TPU (thermoplastic polyurethane) or ETFE (ethylene tetrafluoroethylene).

The barrier effect in the middle layer can be achieved preferably using an ethylene-vinyl alcohol copolymer (EVAL or EVOH), polyoxymethylene (POM) or polyamide (PA), particularly aliphatic polyamide, aromatic polyamide or partially aromatic polyamide (PPA).

The bellows have a total thickness made up of the sum of the thicknesses of all layers. The outer layer has an outer layer thickness, the inner layer has an inner layer thickness and the middle layer has a middle layer thickness.

In a particularly preferred manner, the middle layer thickness is 5 to 800 μm, particularly 10 to 300 μm, particularly preferably 15 to 100 μm, and more preferably 20 to 40 μm.

Additionally or alternatively, it is preferably provided that the middle layer thickness is thinner than the outer layer thickness and/or thinner than the inner layer thickness.

Additionally or alternatively, it is preferably provided that the outer layer thickness is thinner than the inner layer thickness.

In particular, the middle layer thickness amounts to 1% to 25%, preferably 5% to 15%, of the total thickness.

In particular, the outer layer thickness amounts to between 5% and 25%, preferably between 10% and 20%, of the total thickness. This relatively thin outer layer enables the deformation force from the fuel expansion in the outer layer to be reduced.

Regardless of the single- or multi-layer structure, it is preferably provided that the total thickness is 100 to 3,000 μm, particularly 200 to 1,200 μm.

In parts, there may be thicker and thinner regions of the bellows. In particular, it is provided that the defined thickness of the layers and the total thickness in the middle between two folding points are measured.

Preferably the bellows have an additional reinforcing layer at least at one location, yet preferably not over its entire surface. The bellows can thereby be mechanically reinforced at selected locations.

### Structure of the Bellows

Furthermore, it is preferably provided that the bellows are reinforced by structural-mechanical components. To this end, at least one support ring is used in particular. The support rings may be used at the inward-pointing folding points and/or at the outward-pointing folding points.

It is thereby possible to arrange the support rings on the exterior of the wall of the bellows and/or on the interior of the wall of the bellows and/or inside the wall of the bellows. In particular, the support rings may be joined adhesively to the wall of the bellows and/or welded to the wall and/or inserted in tabs in the wall. When arranging the support rings inside the wall of the bellows, it is possible to arrange the support rings between the layers described above.

Since the actual folding function is not to be restricted by the support rings, it is preferably provided to configure the support rings in such a manner that they do not impede the required movement of the volume element. To this end, they are preferably produced of a harder material than the wall of the bellows itself. The volume element is thus held in shape and the support rings assist the desired movement in only one axial direction, here defined as parallel to the fold axis (Z-axis). However, for the support ring, one can also select a softer material than for the wall of the bellows, since the stabilizing effect results from the geometry of the support ring. In particular, the support ring is produced of an elastomer, preferably nitrile-butadiene rubber (NBR).

In a particularly preferred manner, it is provided that a support ring is inserted at least one outward-pointed folding point (external fold) on the inner side of the wall of the bellows. The support ring is preferably not joined to the bellows, but only inserted in them. In particular, such a support ring is inserted on the inner side on the topmost outward fold and at the bottommost outward fold.

In addition or as an alternative to the described inserted support ring, at least one fold, particularly an external fold, can be stabilized by the already described reinforcement layer in a ring shape. In particular, at least the bottommost fold, preferably several or all external folds, is/are stabilized in this way. Preferably, the reinforcement layer is located on the outside of the bellows. Preferably, the reinforcement layer extends entirely to at least one outward pointing folding point and thereby forms a “support ring.”

In addition or as an alternative to the described inserted support ring or the “support ring” formed from the reinforcement layer, at least one outer fold can have a ring-shaped upset. In particular, at least the bottommost fold, preferably several or all external folds, is/are thereby stabilized. The upset is created in the blow-molding tool and represents a thickened region of the bellows. Preferably, the upset extends entirely to at least one outward pointing folding point and thereby forms a “support ring.”

In addition, it is possible to configure some or all folds of the bellows in a bistable manner so that the maximum over-pressure required for complete breathing of the volume element is lower and the minimum under-pressure is higher than compared to bellows with stable folds. Furthermore, the folds are overall less subjected to stress since only the folds that are “open” actually move.

To assist a uniform movement of the bellows along the fold axis (Z-axis) and to simplify breathing and to simultaneously stabilize the folds, it is preferably provided that the intermediate surfaces located between the folding points are designed in a wave-like manner. Preferably, the waves are radially circumferential and can also be described as “folds in the folds.”

### Shape of the Bellows

The bellows are preferably shaped in a conical or frustoconical manner. This shape describes the bellows, particularly in their unfolded state. Alternatively, the bellows are spherical or cylindrical, for example.

Here, the description “conical” or “frustoconical” is not limited to bellows having a round or oval cross-section (defined as perpendicular to the Z-axis). Primarily, this shape specifically describes a tapering of the bellows, starting from a large diameter, particularly at the first element wall, toward a smaller diameter, particularly at the second element wall.

In the cross-section, perpendicular to the fold axis (Z-axis), the bellows may have in particular a round, oval or polygonal shape. In regard to the polygonal shape, the corners are preferably rounded. Furthermore, for optimal volume usage, it is provided that the cross-sectional shape of the bellows is designed in such a manner that the volume element approaches the inner side of the tank contour and/or the contour of any built-in components of the tank.

The conical shape or frustoconical shape relates in particular to at least one section of the bellows, wherein this section comprises multiple folds. Thus, the bellows are preferably entirely conical or frustoconical. Alternatively however, the bellows may also have a section, which is cylindrical or spherical for example, and another section that is conical or frustoconical. Every section thereby extends over multiple folds.

Furthermore, the bellows may also have multiple sections, which extend in each case over multiple folds, wherein these individual sections in themselves are conical or frustoconical.

For optimal usage of the build envelope, it may also be an advantage if the bellows are designed along the fold axis (Z-axis) in a curved, for example banana-shaped, manner.

Additionally or alternatively, for optimal usage of the build envelope, it may also be an advantage to design one side of the bellows more rigidly than another side, so that the bellows move asymmetrically when breathing.

Furthermore, it is preferably provided that in an interior space of a tank, several of the volume elements are used to thereby optimally use the build envelope. One can thereby also use more complex tank geometries, which in turn is advantageous for fitting the tank in the vehicle.

Furthermore, it is preferably provided that the bellows are folded in a spiral-shaped manner. When breathing, in other words the unfolding and folding of the bellows, the bellows execute a rotational movement. It is thereby also possible to arrange the aforementioned support rings in the form of a spiral-shaped spring on to the inwardly pointing folding points and/or the outwardly pointing folding points. This form of structural-mechanical support can simultaneously be used as an elastic element. The function of the “elastic element” will be described in more detail.

### Guide Arrangement

Preferably, the tank comprises at least one guide arrangement in the volume element or outside of the volume element for guiding the bellows when unfolding and folding parallel to its fold axis (Z-axis) and for limiting a movement of the bellows perpendicular to the fold axis. Multiple identical or different guide arrangements can also be used on the same bellows.

Preferably, a possible guide arrangement comprises multiple guide elements attached to the bellows and at least one guide, preferably multiple guides. The guide elements are firmly joined to the bellows and are moveably arranged on the guide or on the multiple guides. For example, the guide is a rod, particularly a telescoping rod, on which the guide elements are guided in a sliding manner.

A possible guide arrangement preferably comprises at least one support element, e.g., in the form of a wall or a crosspiece. Preferably, it is provided to arrange in the interior space of the tank at least one such support element, which extends directly along the outside of the bellows. The support element is firmly joined to the outer wall of the tank. The support element can thereby be directly joined to the outer wall or for example to a baffle plate in the tank. For example, sloshing movements of the fluid in the tank may result in a movement of the bellows. The support element is arranged particularly in such a manner to prevent this movement of the bellows to the greatest extent possible.

The at least one support element is preferably adapted to the shape of the unfolded bellows and can thus also be conical or frustoconical. For example, the support element may also represent a housing surrounding the bellows. Thus, the support element can guide the bellows when breathing and limit a movement perpendicular to the fold axis.

It is preferably provided that the at least one support element is located no more than 40 mm, preferably no more than 20 mm, from the unfolded bellows or is in direct contact with the bellows.

Preferably, a possible guide arrangement is formed by the outer wall of the tank, wherein the outer wall thereby extends into the inside of the bellows and can thus support and guide the bellows at least in the folded state. Due to the fact that the outer wall extends inwardly, an open space is preferably created on its exterior side, in which preferably the filter, particularly the dust filter, is arranged.

### Additional Design of the Bellows

Furthermore, at least one elastic element is preferably provided. The elastic element is designed for example as a spiral spring. The elastic element may be arranged inside the bellows or engage externally on the bellows. The elastic element can place a load on the bellows in the direction of its folded state and/or its unfolded state. The load direction can thereby be selected in such a manner that the elastic element assists the bellows when unfolding or folding.

If the elastic element is arranged inside the bellows, it is preferably inserted into the bellows via the connector and thus through the first element wall. If the elastic element is arranged outside of the bellows, it can be supported for example by the second element wall and the opposite outer wall of the tank. Furthermore, it is possible to have a lever engage at the second element wall. This lever can in turn be subjected to a load via the elastic element.

Alternatively, the manufacturing process can be adjusted in such a manner that the bellows contract during cooling and are thereby folded up in their equilibrium state. The bellows themselves then fulfill the function of the “elastic element.” The spring force of the bellows is adjusted by the material, wall thickness and geometry of the bellows as well as by their manufacturing process.

In addition or as an alternative to the elastic element, the tank may have an actuator. The actuator is a pump for example, with which the gas is pumped into or suctioned out of the volume element.

In addition, the actuator may also engage mechanically with the volume element, for example by means of the lever described above, to actively change the volume of the volume element. To this end, an electric motor-driven, electromagnetic or piezo-electric actuator is used for example.

By means of active assistance, be it through the elastic element or the actuator, it is possible to increase the efficiency of the volume element since prompt responsiveness, for example when refueling, is possible. Furthermore, full functionality can be ensured during refueling. Moreover, one can opt for greater wall thicknesses or material strengths and thus a more robust design, wherein simultaneously the volume element exhibits prompt responsiveness due to the active assistance. Functional reliability at lower temperatures is also improved by the active assistance.

Furthermore, it is preferably provided that the tank has at least one sensor for determining the volume of the volume element. The sensor may operate for example as a distance sensor, angle sensor or pressure sensor.

The distance sensor preferably determines the distance between the two opposing element walls of the volume element or for example the distance between the second element wall and the opposing outer wall of the tank (preferably the lower outer wall).

The aforementioned lever, which engages particularly at the second element wall of the volume element, is preferably hinged in a rotatable manner in the tank. Thus, the angle of the lever for example can be determined by means of a corresponding sensor at the lever. Given a known geometry of the structure, the volume of the volume element can be calculated from this angle.

In addition, the pressure can be determined in the interior space (outside of the volume element) and/or in the volume element. Based on this pressure and if applicable based on the values of the described elastic elements and/or the active assistance with the actuator, the volume of the volume element can be calculated.

Furthermore, it is also possible to combine several of the described sensors to thereby calculate the volume of the volume element.

Preferably, a method is provided for the active assistance of the volume element using the described actuator, wherein the actuator is controlled as a function of the volume, determined in particular using at least one of the sensors, of the volume element.

### Replacement or Repair of the Volume Element

According to a preferred variant, the volume element is attached to a lid so that by removing the lid, which closes the outer wall of the tank, the volume element is removed. A new volume element can be attached to the same lid or on another lid. However, it shall thereby be noted that the lid and the hole to be covered by the lid are to be designed according to the size of the volume element.

Preferably, the tank comprises at least one detachable holding arrangement. This holding arrangement is designed to hold at least two adjoining folds of the bellows in the folded state.

According to a variant, the detachable holding arrangement, for example in the form of a clip mounted on the outside or inside, holds together only some of the folds of the bellows, wherein the remaining folds can fold together and unfold again to thereby allow the volume element to breathe. After a certain operating period, the holding arrangement can be released and if applicable be applied to other, already used folds.

The folds held together by the holding arrangement thus form a reserve region of the bellows. The remaining folds can execute the breathing and thus form an active region of the bellows. Both the active region as well as the reserve region each comprise multiple folds.

After a certain operating period, after wear and tear, or when a leak appears, the holding arrangement can be detached at the reserve region so that these folds become active. In addition, it is possible to set the same holding device or another holding device and thereby place the previous folds of the active region in a passive state.

The at least one holding arrangement is actuated for example by means of a lid in the outer wall of the tank. By opening the lid, one can reach by hand inside the tank and thus get to the volume element or reach directly inside the volume element.

If the holding arrangement is located inside the volume element, access to the bellows is preferably made possible via the lid. Furthermore, the volume element may also open directly to the surroundings, wherein the lid can be omitted.

Alternatively or additionally, it is also provided that the holding arrangement can be detached and/or placed from the outside by an actuating signal. To this end, a corresponding actuatable actuator is located on the holding arrangement.

The holding arrangement may be attached externally on the bellows. To this end, one can use a clip for example, which clasps multiple folds and thus holds them together in their passive state.

In addition, both outside of and inside the bellows, it is possible to use a holding arrangement that snaps together or holds together magnetically for example.

Furthermore, it is preferably provided that the bellows are subdivided in the interior into two regions by a separating wall; the one region is thereby initially designed as an active region. In the second region, there is provided the holding arrangement that holds together the individual folds in a folded state. The two regions or the volumes of the two regions are connected to each other by means of an opening in the separating wall.

Furthermore, it is preferably provided that at least two volume elements, each having bellows, are arranged in the interior space of the tank. One of the two volume elements is initially active and can breathe due to its connection to the gas-carrying line. The second volume element is designed as a reserve volume element and remains in its folded state.

In particular, the described holding arrangement is provided on the reserve volume element to maintain the folded state of all folds. After a certain operating period, after wear and tear or a leak, the active volume element is replaced by the reserve volume element.

According to one variant, the active volume element is attached for example by means of its connector, which is located on the first element wall, to the outer wall of the tank and is connected to the gas-carrying line via the connector. The reserve volume element is arranged independently of the active volume element at a suitable location in the interior space. The described holding arrangement holds the reserve volume element in the folded state. In particular, this reserve volume element has its own connector. This connector is closed preferably by means of a closure, for example a cap, so that no fuel enters inside the reserve volume element. When changing the volume element, the first volume element is disconnected from the gas-carrying line. The first volume element can then remain for example inside the tank or can be removed from the interior space via the corresponding opening. To this end, a relatively small opening can be used, since it is possible to reduce in size or crumple up the first volume element in the interior space so that it can be removed via the relatively small opening. Thereupon, the closure at the connection of the reserve volume element is detached and the reserve volume element is connected to the gas-carrying line. Furthermore, the holding arrangement is also detached at the reserve volume element so that the reserve volume element can breathe.

According to an additional variant, it is provided that two volume elements are arranged in the interior space, wherein each volume element is connected via its own connection directly to the gas-carrying line. To initially design one of the two volume elements as a “reserve volume element,” this volume element for example has the described holding arrangement to hold its folds in the folded state. In the changing process, the holding arrangement of the reserve volume element is detached and the holding arrangement is placed on the first volume element.

Alternatively or additionally, it is also possible to shut off the inflow and outflow of the gas to one of the two volume elements, for example by means of a three-way valve in the corresponding line, by means of which the desired volume element remains in the folded state. It is thereby possible under some circumstances to omit the holding arrangement. Pressure relief valves are then connected to each volume element to ensure that the closed volume element always remains in the displaced state despite diffusion through its wall.

According to another variant, it is provided that only one of the two volume elements is connected directly to the gas-carrying line via the connector. The second volume element (reserve volume element) is connected directly to the first volume element via its connector. For example, the connector of the reserve volume elements is inserted in the second element wall of the first volume element. Here, too, holding arrangements can again be used on both volume elements to thus define which of the two volume elements is to breathe.

The invention also comprises a motor vehicle having at least one tank as described above.

Additional details, features and advantages of the invention are found in the description and drawings below. Depicted are:

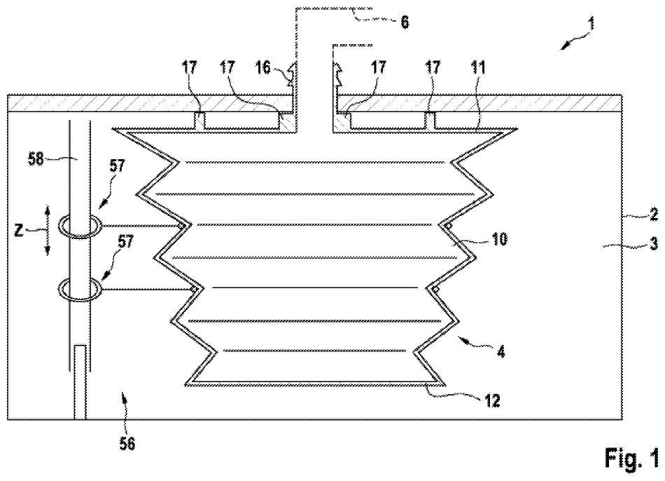

FIGS. 1 to 9 various embodiments of the tank according to the invention having a volume element designed as bellows,

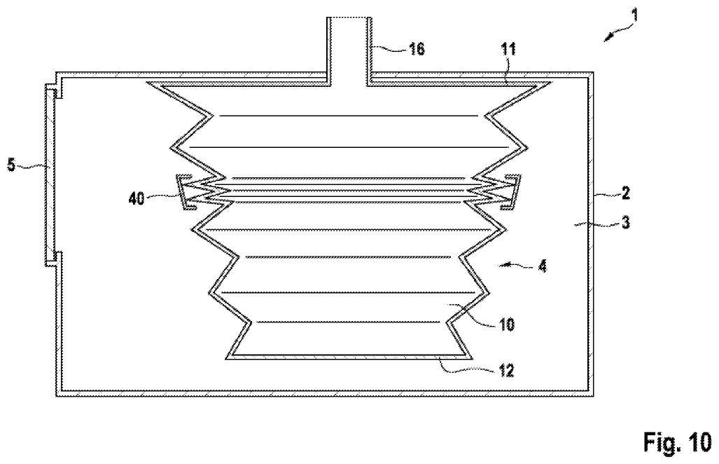

FIGS. 10 to 13 various embodiments of the tank according to the invention having a volume element, wherein the bellows have active and passive regions,

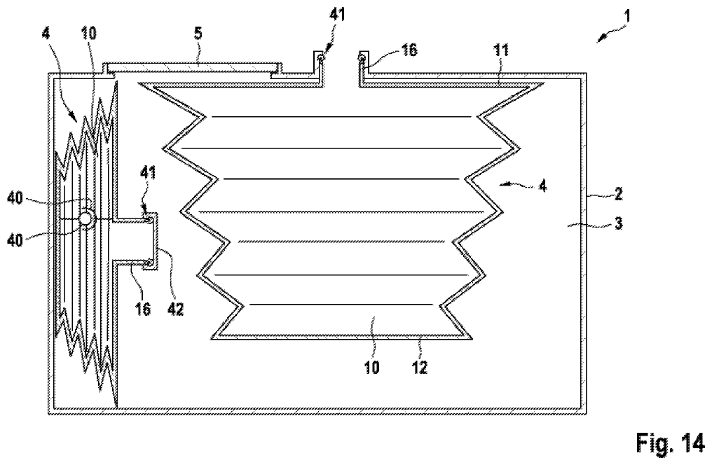

FIGS. 14 to 17 various embodiments of the tank according to the invention having two volume elements, each designed as bellows,

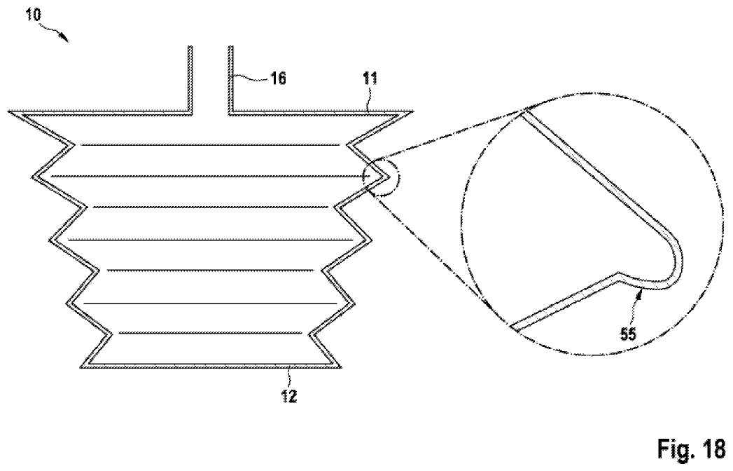

FIG. 18 a volume element designed as bellows with bistable folds, and

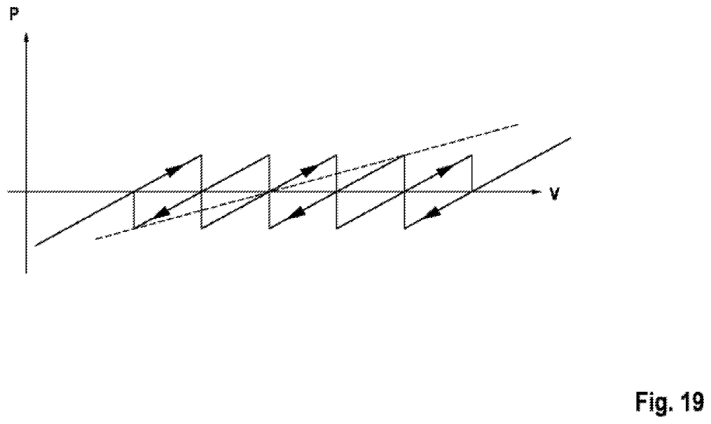

FIG. 19 a schematic illustration regarding FIG. 18,

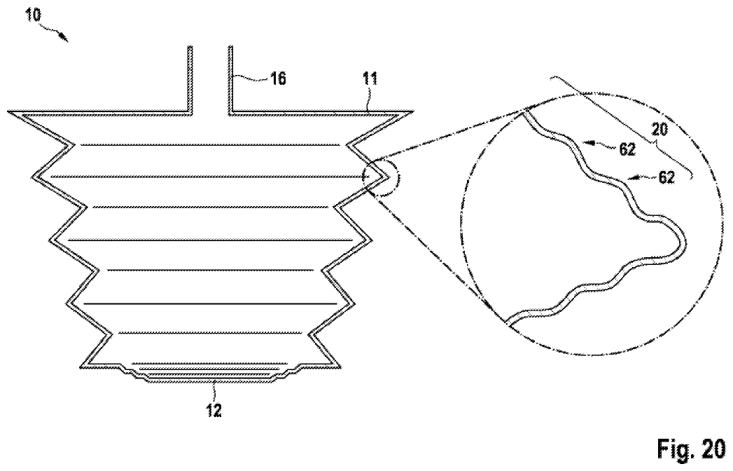

FIG. 20 a volume element designed as bellows having waves on the intermediate surfaces, and

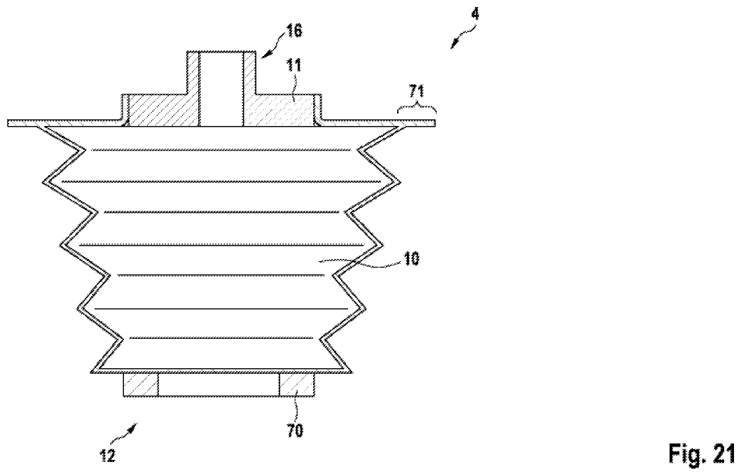

FIG. 21 a volume element having additional advantageous designs.

The drawings schematically show various embodiments of a tank 1. The tank 1 is used in a motor vehicle in particular.

The tank 1 comprises an outer wall 2, which forms an interior space 3 for holding fuel. There is at least one volume element 4 in the interior space 3. A lid 5 for opening an opening may be designed on the outer wall 2.

A gas-carrying line 6 leads to the tank 1. Said line is connected in a gas-carrying manner to the at least one volume element 4.

Various embodiments of the tank 1 and the volume element 4 are described in detail below. These various embodiments can be preferably combined with each other.

FIG. 1 shows that the volume element 4 comprises two opposing element walls, specifically a first element wall 11 positioned at the top and an opposing element wall 12. The two element walls 11, 12 of the volume element 4 are connected to each other via bellows 10. When the volume element breathes, the bellows 10 move along the drawn-in fold axis Z.

A connector 16 in the form of a nipple is designed at the first element wall 11. This connector 16 protrudes through the outer wall 2 outwards and is connected to the gas-filling line 6.

Furthermore, FIG. 1 shows the possibility of arranging at least one spacing element 17 between the first element wall 11 and the outer wall 2 of the tank 1. The outer wall 2 of the tank 1 can be produced by inflating a plastic mold. The volume element 4 can thereby be arranged in the tank 1 being formed prior to inflation. After inflating the outer wall 2, it cools down. So as not to damage the volume element 4 due to heating during inflation or subsequent cooling, said volume element is preferably set at a distance by the at least one spacing element 17.

Furthermore, FIG. 1 shows the schematic arrangement of a guide arrangement 56 as an optional design. The guide arrangement 56 comprises multiple guide elements 57. The guide elements 57 are firmly connected to the outer side of the bellows at various positions. Furthermore, the guide arrangement 56 comprises a guide 58. The guide 58 is here designed as a telescoping rod that extends along fold axis Z. The guide elements are guided in a sliding manner along the guide 58. The schematic illustration in FIG. 1 shows only one guide 58 solely for illustrative purposes. However, several of these guides 58 can in fact be used. In particular, more than the two depicted guide elements 57 are also used.

The guide arrangement 56 guides and stabilizes the bellows 10 in the folding and unfolding process, and thus in its movement parallel to the fold axis Z. A movement perpendicular to the fold axis Z is prevented or limited by the guide arrangement 56.

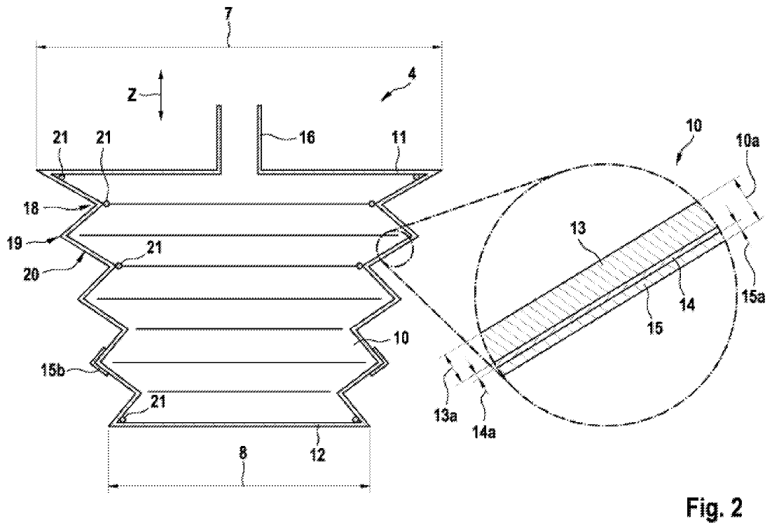

In a detailed illustration, FIG. 2 depicts the multi-layer structure of the wall of the bellows 10 having inner layer 13, middle layer 14 and outer layer 15. The bellows 10 has a total thickness 10a made up of the sum of the thicknesses of all layers. The outer layer 15 has an outer layer thickness 15a, the inner layer 13 has an inner layer thickness 13a and the middle layer 14 has a middle layer thickness 14a. The dimensions and materials for the layers were already advantageously defined in the general portion of the description. The outer layer thickness 15a is thinner than the inner layer thickness 13a.

Furthermore, FIG. 2 shows that the bellows alternatingly have a plurality of inward pointing folding points 18 and outward pointing folding points 19. There are intermediate surfaces 20 in each case between the folding points. FIG. 2 depicts the arrangement of support rings 21 on the interior side of the folding points 18, 19. It is possible to arrange support rings 21 at all or some folds. Furthermore, it is possible to arrange the support rings 21 both inside as well as outside or between the layers 13, 14, 15.

It is provided in particular that a support ring 21 is inserted at at least one outward pointing folding point 19 (external fold) on the inner side of the wall of the bellows 10. The support ring 21 is preferably not joined to the bellows 10, but only inserted.

In addition or as an alternative to the described rigid support ring 21, at least one fold, particularly an external fold, can be stabilized by a reinforcement layer 15b. As FIG. 2 shows, the reinforcement layer 15b is preferably located on the outer side of the bellows 10 and extends in a ring-shaped, fully circumferential manner at at least one outward pointing folding point 19 and thus forms a “support ring.”

In addition or as an alternative to the described rigid support ring 21 or the “support ring” formed from the reinforcement layer 15b, at least one outer fold can have an upset 71, which forms a “support ring.” This variant is described in FIG. 21. In regard to the upset 71, the blow-molding tool can produce a material indentation on the inner side of the folding point, said indentation supporting the reinforcing effect of the upset 71.

Furthermore, FIG. 2 depicts perpendicular to the Z axis a large diameter 7 of the volume element 4 at the first element wall 11 and a small diameter 8 of the volume element 4 at the second element wall 12. This design of the diameters 7, 8 results in a frustoconically shaped volume element 4. The side with the larger diameter 7 is preferably arranged at the top and contacts the outer wall 2.

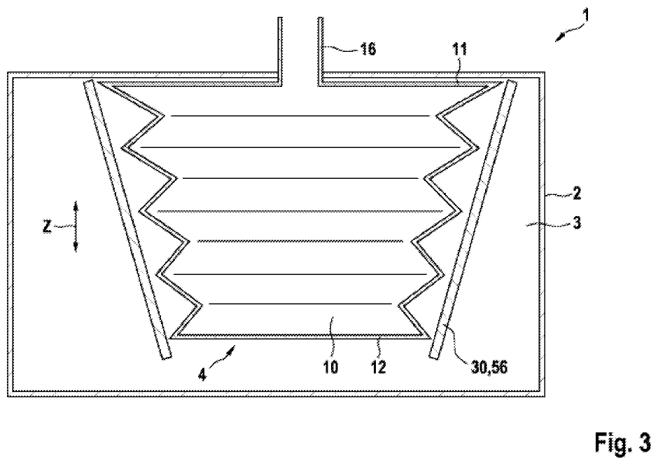

FIG. 3 depicts a support element 30 in the form of a housing as a guide arrangement 56. This support element 30 is arranged directly on the outer side of the unfolded bellows 10 and limits any movement of the bellows 10, for example caused by the fluid moving in the interior space 3.

In addition, the support element 30, designed as a guide arrangement 56, guides the bellows during folding and unfolding, and thereby limits any movement perpendicular to fold axis Z.

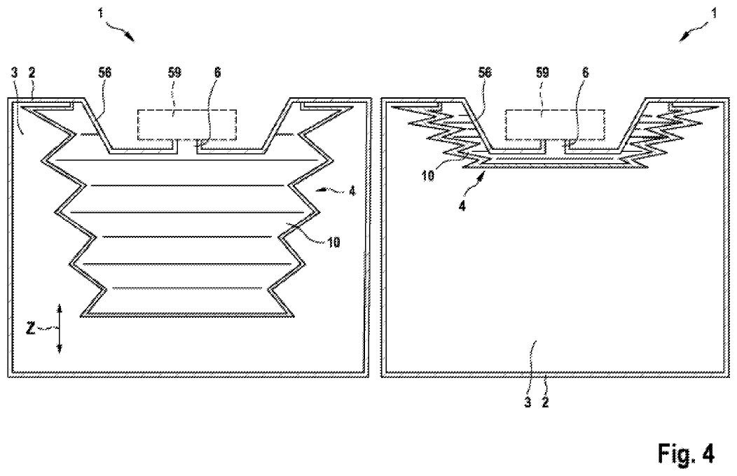

FIG. 4 depicts another possible design of the guide arrangement 56. In this regard, the left side of FIG. 4 shows the folded bellows 10. On the right side, FIG. 4 depicts the folded bellows. According to FIG. 4, the guide arrangement 56 is formed by the outer wall 2 extending into the interior space of the bellows 10. This region of the outer wall 2 can alternatively also be formed by a lid 5, which represents a part of the outer wall 2.

By the outer wall 2 extending into the interior of the bellows 10 according to FIG. 4, this region of the outer wall 2 can at least partially support and/or guide the bellows. Thus, this inwardly curved region of the outer wall 2 also limits a movement of the bellows 10 perpendicular to the fold axis Z.

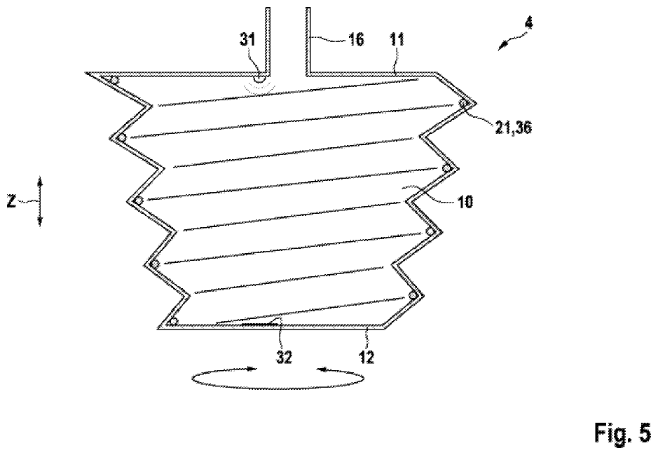

FIG. 5 depicts a possible design of the bellows 10 having spiral-shaped folding. When unfolding and folding the bellows 10 along the Z axis, the second element wall 12 rotates relative to the first element wall 11 about the Z axis.

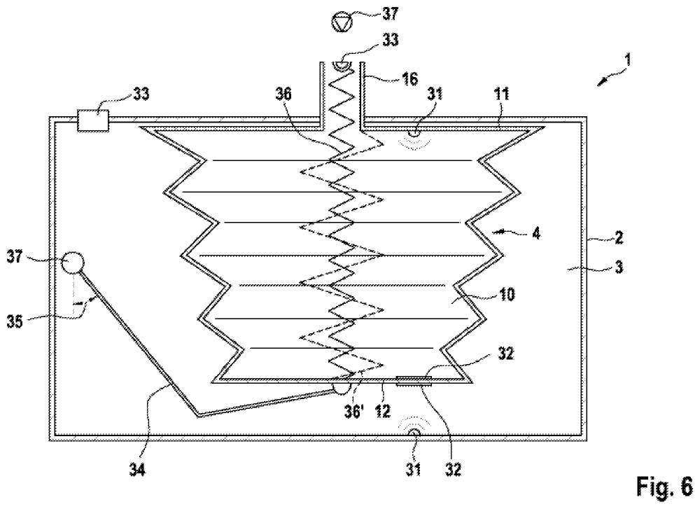

Here, the support ring 21 is designed in a spiral shape and can simultaneously also be used as an elastic element 36. The elastic element 36 is explained in more detail using FIG. 6.

Furthermore, FIG. 5 shows the use of a distance sensor 31. Here, the distance sensor 31 is arranged on the inner side of the first element wall 11 and it measures the distance to the second element wall 12. To do so, there is preferably on the second element wall 12 a corresponding counter-piece 32, designed as a reflector for example. The distance sensor 31 can operate optically or electromagnetically or acoustically, for example. By measuring the distance between the two element walls 11, 12, a corresponding control unit can calculate the current volume of the volume element 4. The use of the distance sensor 21 is thereby independent of any spiral-shaped folding of the bellows 10.

Given the spiral-shaped folding, the counter-piece 32 rotates relative to the distance sensor 31. As a result, the distance sensor 31 can also record an angle of rotation to the counter-piece 32 and thereby deduce the distance.

Besides using a distance sensor 31 inside the volume element 4, FIG. 6 shows other possible sensors that can also be used to obtain information about the volume of the volume element 4.

Thus, FIG. 6 shows for example a distance sensor 31 on the bottom of the outer wall 2, which measures the distance to the second element wall 12, if applicable also using a counter-piece 32.

Additionally or alternatively, a pressure sensor 33 can be used, which measures for example the pressure in the interior space 3 outside of the volume element 4 or (not depicted) the pressure in the volume element 4.

Aside from the sensors, FIG. 6 depicts a possible arrangement of an elastic element 36, here in the form of a spring. In the depicted example, the elastic element 36 is arranged inside the volume element 4. The elastic element 36 is braced inside the volume element 4 against the second element wall 12 and is supported on the opposite side for example inside the connector 16. In particular, this elastic element 36 can also be introduced through the connector 16 into the interior of the volume element 4. Alternatively, the elastic element can be attached to the upper wall as is shown with 36′ in FIG. 6.

As an alternative to this, it is also possible to arrange an elastic element 36 on the bottom side of the second element wall 12 and brace it against the outer wall 2.

Furthermore, FIG. 6 depicts the use of a lever 34, which is rotatably hinged in the interior space 3 and is connected to the second element wall 12. The movement of this lever can be recorded for example using an angle sensor 35, by means of which information can be obtained regarding the current volume of the volume element 4.

Furthermore, the tank 1 may comprise at least one actuator 37 with which it is possible to actively influence the volume of the volume element 4. This can be done particularly based on the volume determined by the sensors 31, 33, 35.

A possible actuator 37 is a pump, with which gas can be pumped or suctioned into the volume element 4 via the connector 16. In addition, it is possible to arrange an actuator 37 in the form of an electric drive on the lever 34. The lever 34 can thereby be moved with the actuator 37, by means of which the second element wall 12 is in turn moved with respect to the first element wall 11.

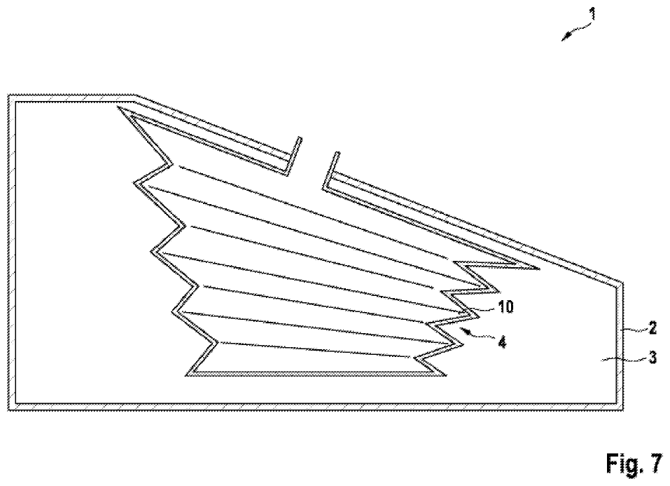

FIG. 7 depicts in a purely schematic manner an embodiment in which the bellows 10 is designed more stiffly on one side than on an opposite side. This design of the bellows 10 can be combined with all other designs presented here. FIG. 7 highlights how the various rigidities of the folds of the bellows 10 make it possible for the bellows to unfold and fold asymmetrically. In this way, the bellows 10 can be adapted to specific geometries of the interior space 3.

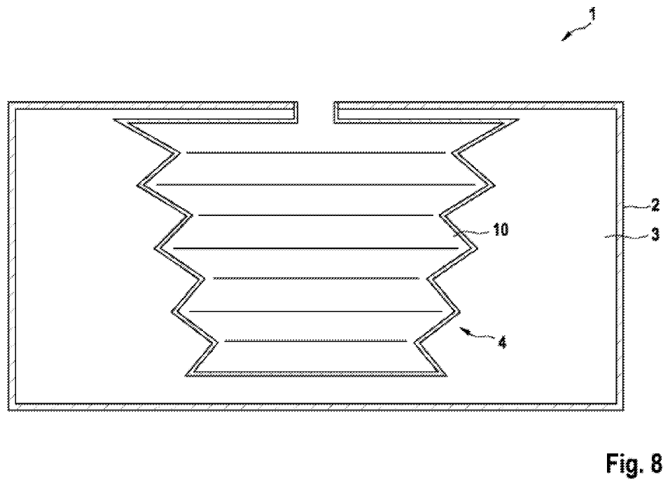

FIG. 8 highlights in a purely schematic manner that the bellows can be directly open in an upward direction and can be connected to the surroundings via a corresponding opening in the outer wall 2. In this design, no gas-carrying line 6 is necessary; instead, the interior of the bellows 10 opens directly to the surroundings.

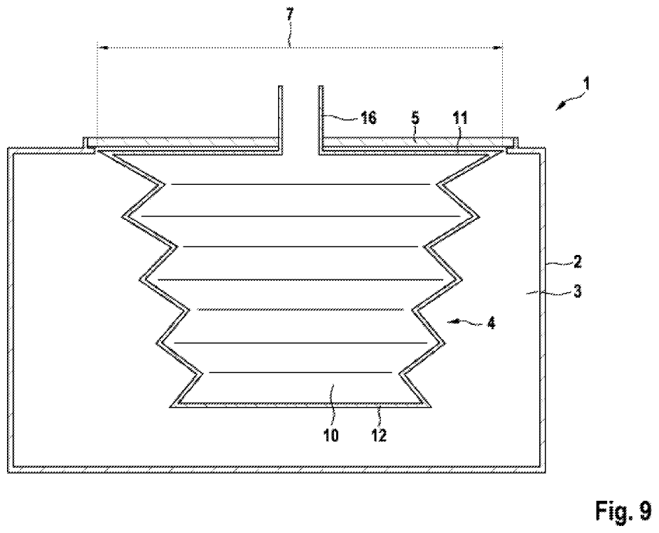

FIG. 9 depicts a simple way to replace the volume element 4. According to FIG. 9, a lid 5 is arranged in the outer wall 2. The volume element 4 is arranged on the inner side of this lid 5. The lid 5 closes an opening, which is large enough to remove the lid along with the volume element 4 from the interior space 3.

FIG. 10 shows a variant in which multiple adjoining folds of the bellows 10 are held together in a folded state by means of a holding arrangement 40. In this example, the holding arrangement 40 is designed as a clip, which is applied on the bellows 10 from the outside. The holding arrangement 40 thus holds certain folds of the bellows 10 together, which form a reserve region of the bellows 10. By removing this holding arrangement 40 and if applicable by placing the holding arrangement 40 at other folds of the bellows 10, the reserve region can be activated.

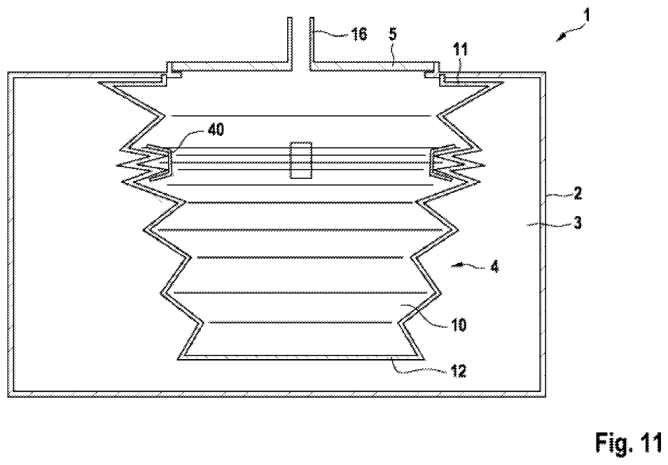

FIG. 11 shows that the holding arrangement 40, as was explained by means of FIG. 10, can also be arranged inside the bellows 10. It is thereby particularly provided that the lid 5 is arranged in the outer wall 2 of the tank 1 in such a manner that by opening the lid, the interior of the bellows 10 is directly accessible. The holding arrangement 40 can thereby be detached by a person.

The lid 5 shown in FIG. 11, which allows direct access inside the bellows 10, can also be used independently of the depicted holding arrangement 40 to allow a repair of the bellows 10 from the inside, for example.

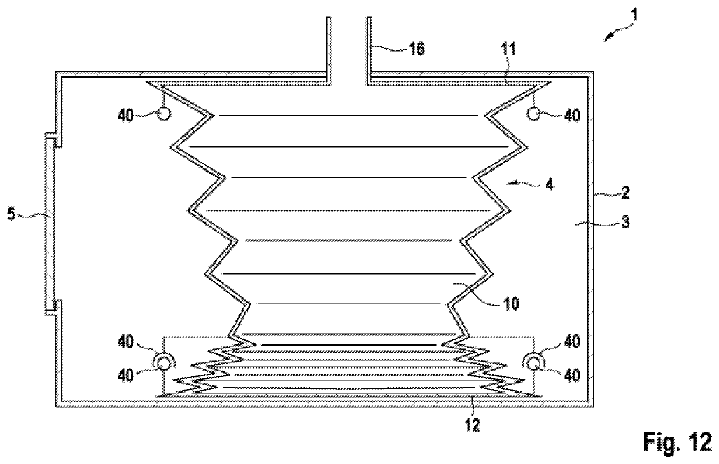

FIG. 12 depicts a design of the holding arrangement 40 having two opposing elements, which interlock or otherwise hold together, for example magnetically. In the illustration according to FIG. 12, the lower half of the bellows 10 is passive and serves as a reserve. After corresponding wear or for example a leak, the holding arrangement 40 can be placed in such a manner that the upper half of the bellows 10 becomes passive and the lower half of the bellows 10 is used for breathing.

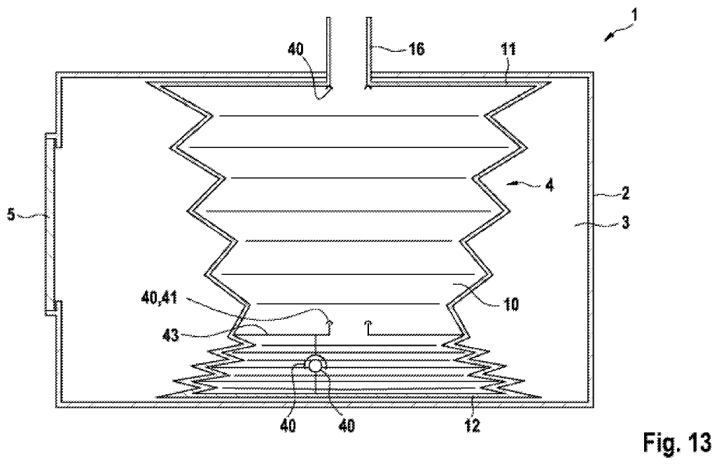

FIG. 13 depicts a similar variant as in FIG. 12. However, here the holding arrangement 40 is located inside the bellows 10 in the form of a quick connector. The advantage of the device is that a leak in the upper part would not influence emissions because it is sealed off.

Furthermore, FIG. 13 shows that the bellows 10 is subdivided by a separating wall 43. The separating wall 43 has an opening so that the two regions of the bellows are connected to each other. Located at this opening as well as at the first element wall 11 or at the connector 16 is the holding arrangement 40, which allows one to connect this opening of the separating wall 43 directly to the connector 16. This occurs when the holding arrangement 40 of the lower region of the bellows is detached and the upper region of the bellows 10 is set to be passive. The holding arrangement 40 in the first volume element 4 is simultaneously designed as a connecting arrangement 41, which allows a simple and detachable connection of the opening of the separating wall 43 to the gas-carrying line 6. To release the lower holding arrangement 40 (e.g., in the workshop, during a repair or a service), one can connect the connecting arrangements 41 at the top, and pressurize the volume element 4 until the holding arrangement 40 tears.

FIG. 14 shows a variant in which two volume elements 4 are located in the interior space 3. While the one volume element 4 breathes through its connection to the gaseous line 6, the reserve volume element 4 remains in the folded state, held by the holding arrangement 40, at any location in the interior space 3. In particular, the connector 16 of the reserve volume element 4 is thereby closed by a closure 42 (cap) so that no fuel can enter inside the reserve volume element 4. When replacing the volume elements 4, the first volume element 4 is pulled off. The closure 42 is removed from the reserve volume element 4 so that the connector 16 of the reserve volume element 4 can be connected to the corresponding opening in the outer wall 2. To this end, detachable connection arrangements 41 are preferably provided on the outer wall 2 and at the connectors 16.

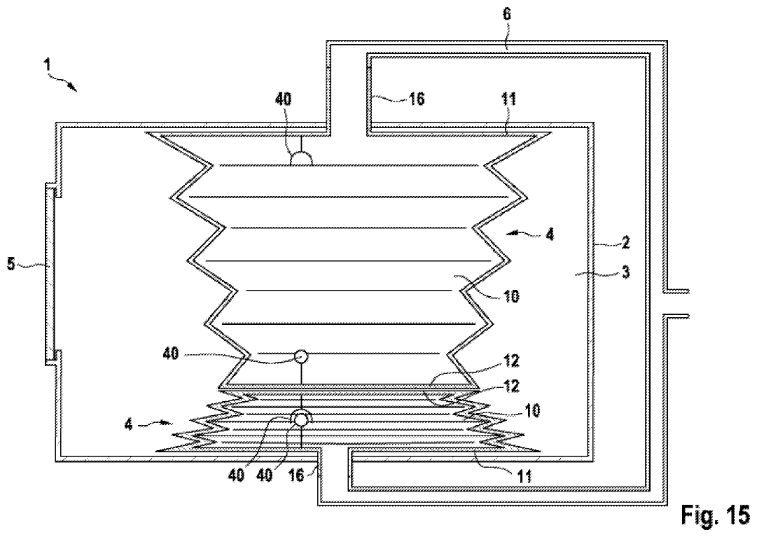

FIG. 15 depicts a variant, in which there are also two volume elements 4 in the interior space 3. The reserve volume element 4 is thereby again held in the folded state by means of a holding arrangement 40. Both volume elements 4 are always connected by their own connectors 16 to the common gas-carrying line 6. By the corresponding detachment and placement of the holding arrangements 40 in the first volume element 4 or in the reserve volume element 4, one can determine which volume element remains in the folded state and which volume element 4 breathes.

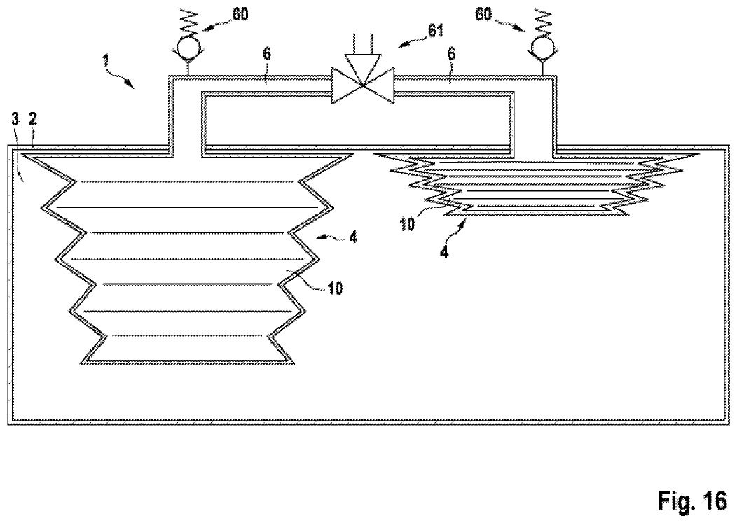

Like FIG. 15, FIG. 16 shows two volume elements 4, each as bellows 10, inside tank 1. Both volume elements 4 are connected via their own gas-carrying lines 6 to the surroundings. However, in the variant according to FIG. 16, no holding arrangements 40 are required. According to FIG. 16, both lines 6 of both volume elements 4 are connected to each other via a three-way valve 61. By the corresponding switching of the three-way valve 61, either one or the other volume element 4 can be utilized.

Preferably, pressure relief valves 60 are then used at each volume element 4 to ensure that the closed volume element 4 always remains in a displaced state, despite diffusion through its wall.”

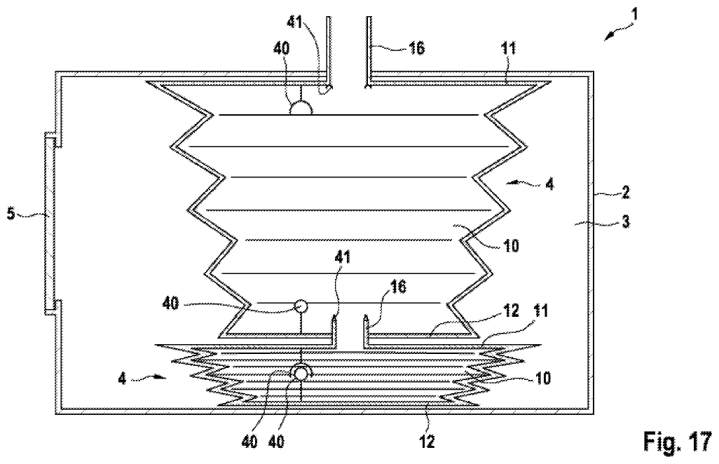

FIG. 17 also shows an arrangement having two volume elements 4 in the interior space 3. This arrangement corresponds to the illustration in FIG. 9 with the difference that it hereby does not involve a single bellows 10, which is subdivided by a separating wall 43, but two separate bellows 10, which are connected to each other. In contrast to FIG. 13, the first volume element 4 according to FIG. 17 has a holding arrangement 40, which is constructed separately from the connection arrangement 41.

FIG. 18 shows the possibility of designing the folds of the bellows 10 in a bistable manner. In this regard, FIG. 18 shows a bistable fold 55, wherein in particular multiple or all folds can be designed as bistable folds 55.

Relating to FIG. 18, FIG. 19 shows the advantageous trend of the volume in the bellows 10 as a function of the pressure in the volume element 4 as a dashed line using bistable folds 55 for all folds compared to conventional stable folds having a continuous line.

FIG. 20 depicts in a purely schematic illustration for all embodiments shown here that to assist a uniform movement of the bellows 10 along the fold axis Z and to simplify breathing and to simultaneously stabilize the folds, it may be optionally provided that the intermediate surfaces 20 located between the folding points have waves 62 and are thus designed in a wave-shaped manner or having a wave structure.

The first element wall 11 and/or the second element wall 12 can be designed as rigid panels. Alternatively, one can integrate circumferential radial folds in the bottom, so that the bottom can move slightly upward inside the outer folds to further decrease the minimum volume. In this case, the element wall 12 is no longer a rigid panel. FIG. 20 depicts this design, which can be used with or without the wave 62.

FIG. 21 depicts additional possible embodiments of the volume element 4, which can be used individually or in combination with other features of the invention:

Relating to FIG. 2, support rings 21 or a reinforcement layer 15b were described to form a type of “support ring.” In addition or as an alternative to this, FIG. 21 depicts a fully circumferential upset 71 for illustrative purposes on a fold, which forms by means of its material thickening a “support ring.”

Furthermore, FIG. 21 depicts a rigid first element wall 11. The bellows 10 is blow-molded on to the first element wall 11. The same structure also results when the first element wall is adhesively joined or welded to the bellows.

Furthermore, FIG. 21 shows that the bottom of the bellows 10 or the second element wall 12 may comprise a ring-shaped structure-reinforcement element 70.

### LIST OF REFERENCE SIGNS

1 Tank
2 Outer wall
3 Interior space
4 Volume element
5 Lid
6 Gas-carrying line
7 Large diameter
8 Small diameter
10 Bellows
10a Total thickness
11 First element wall
12 Second element wall
13 Inner layer
13a Inner layer thickness
14 Middle layer
14a Middle layer thickness
15 Outer layer
15a Outer layer thickness
15b Reinforcement layer
16 Connector
17 Spacing element
18 Inward pointing folding point
19 Outward pointing folding point
20 Intermediate surfaces
21 Support rings
30 Support element as guide arrangement 56
31 Distance sensor
32 Counter-piece
33 Pressure sensor
34 Lever
35 Angle sensor
36 Elastic element
37 Actuator
40 Holding arrangement
41 Connecting arrangement
42 Closure
43 Separating wall
50 Outgoing flow
51 Leak
55 Bistable fold
56 Guide arrangement
57 Guide element
58 Guide
59 Filter
60 Pressure relief valve
61 Three-way valve
62 Wave structure
70 Structure-reinforcing element
71 Upset

1. A fuel tank for holding a fluid in a motor vehicle, the fuel tank comprising:
an outer wall, which forms an interior space for holding the fluid,
at least one volume element arranged in the interior space for holding gas, in particular air, and
an opening, in particular a line carrying the gas, between the at least one volume element and surroundings of the tank for changing a volume of the volume element,
wherein the at least one volume element includes bellows.

2. The tank according to claim 1, wherein the bellows have at least two layers, specifically an inner layer and an outer layer, and
wherein the inner layer is manufactured of a different material than the outer layer.

3. The tank according to claim 1, wherein the bellows have at least three layers including an inner layer having an inner layer thickness, a middle layer having a middle layer thickness, and an outer layer having an outer layer thickness, and
wherein the middle layer is manufactured of a different material than the inner layer and the outer layer.

4. The tank according to claim 3, wherein the middle layer thickness is 5 to 800 μm.

5. The tank according to claim 3, wherein the middle layer thickness is thinner than the outer layer thickness and/or thinner than the inner layer thickness.

6. The tank according to claim 3, wherein the middle layer thickness is 1% to 25% of a total thickness of the bellows.

7. The tank according to claim 1, wherein the volume element further includes:
at least one support ring disposed on an inner side of an outward pointing folding point of the bellows, and/or
at least one ring-shaped reinforcement layer disposed on an outer side of the outward pointing folding point of the bellows, and/or
at least one ring-shaped upset disposed at the outward pointing folding point of the bellows.

8. The tank according to claim 1, wherein the bellows are conical or frustoconical.

9. The tank according to claim 1, wherein the bellows are folded in a spiral-shaped manner.

10. The tank according to claim 1, wherein the at least one volume element further includes a first element wall and a second element wall, and the first and second element walls are joined to the bellows or are at least partially defined by the bellows.

11. The tank according to claim 10, wherein at least one of the first element wall or the second element wall is rigid, and the bellows are:
blow-molded to the at least one of the first element wall or the second element wall, or
joined in a material-bonded or formfitting manner to the at least one of the first element wall or the second element wall.

12. The tank according to claim 10, wherein at least one of the first element wall or the second element wall is rigid and has multiple layers of various plastics.

13. The tank according to claim 10, wherein at least one of the first element wall or the second element wall is formed by the bellows and has at least one ring-shaped, structure-reinforcement element.

14. The tank according to claim 10, wherein at least one spacing element is arranged between the first element wall and the outer wall.

15. The tank according to claim 1, further comprising at least one guide arrangement for guiding the bellows when unfolding and folding parallel to a fold axis (Z) thereof and for limiting a movement of the bellows perpendicular to the fold axis (Z).

16. The tank according to claim 1, further comprising a protective sleeve surrounding the bellows.

17. The tank according to claim 1, further comprising at least one spring,
wherein the elastic spring is arranged to place a load on the bellows in a direction of a folded state and/or an unfolded state.

18. The tank according to claim 1, further comprising at least one sensor for determining the volume of the volume element.

19. The tank according to claim 1, further comprising at least one actuator for actively changing the volume of the volume element.

20. The tank according to claim 1, further comprising at least one detachable holding arrangement, which holds together at least two adjoining folds of the bellows in a folded state thereof.

21. The tank according to claim 1, wherein the at least one volume element includes at least one active volume element and at least one reserve volume element in the interior space, and
wherein a volume of the at least one active volume element is configured to be changed via a connection to the line carrying the gas, while the at least one reserve volume element remains in a folded state thereof until used.

22. The tank according to claim 21, wherein the at least one active volume element and the at least one reserve volume element are each simultaneously connected via a separate connector (16) to the line carrying the gas.

23. The tank according to claim 21, wherein volumes of the at least one active volume element and the at least one reserve volume element are connected directly to each other.
